(19) United States
(12) Patent Application Publication
(10) Pub. No.: US 2014/0164123 A1
(43) Pub. Date: Jun. 12, 2014

(54) User Interface for Accessing Information About a Retail Store

(71) Applicants: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(72) Inventors: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(21) Appl. No.: 13/710,163

(22) Filed: Dec. 10, 2012

(51) Int. Cl. G06Q 30/06

(52) U.S. Cl. CPC G06Q 30/0623
USPC 705/14.58; 705/26.61

(57) ABSTRACT

The present invention extends to methods, systems, and computer program products for providing a conversational user interface (CUI) which interacts audibly with a customer of a retail location. The CUI can ask questions to or respond to questions from the customer, provide audible information regarding products or services available within the retail location, or otherwise assist the customer as the customer shops at the retail location. The CUI can be provided on virtually any device capable of outputting audio content including portable devices such as mobile phones, smart phones, tablets, gaming devices, and stationary devices such as televisions, monitors, or other display devices.

### CROSS-REFERENCE TO RELATED APPLICATIONS

This application claims priority to U.S. Provisional Patent Application No.: 61/569,110 which was filed on Dec. 9, 2011 and titled “User Interface For Accessing Information About A Retail Store.”

### BACKGROUND

When shopping, many consumers have trouble finding the right products and choosing between competing products. Currently, consumers must walk through stores, occasionally guided by store employees, looking at in-store signs to guide themselves to the products that they want. Once they find a product or group of similar products, the consumer may need to read product information from product tags or labels or talk with a store employee to learn more about the particular products.

Occasionally, products are advertised in stores in ways that inform the consumer about the particular product. In-store advertisements are generally designed to inform consumers about specific products and entice consumers to purchase those products. Despite the potential effectiveness of current in-store advertising systems, such advertisements generally include only one advertising approach that may not effectively address the needs of many types of consumers or provide certain consumers with the type of information that is most effective to entice each consumer to purchase the advertised product.

### BRIEF SUMMARY

The present invention extends to methods, systems, and computer program products for providing a conversational user interface (CUI) which interacts audibly with a customer of a retail location. The CUI can ask questions to or respond to questions from the customer, provide audible information regarding products or services available within the retail location, or otherwise assist the customer as the customer shops at the retail location. The CUI can be provided on virtually any device capable of outputting audio content including portable devices such as mobile phones, smart phones, tablets, gaming devices, and stationary devices such as televisions, monitors, or other display devices.

In one embodiment, the present invention provides a method for providing a conversational user interface to a customer of a retail location. A computing system identifies a customer of a retail location, and accesses stored information about the customer. The computer system then communicates audibly with the customer to provide information about products available within the retail location, and responds to communications received from the customer regarding the products.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary environment in which the present invention can be implemented;

FIGS. 2A and 2B illustrate an exemplary conversational user interface;

FIGS. 3A and 3B illustrate an exemplary conversational user interface that includes an avatar;

FIG. 4 illustrates an exemplary conversational user interface that includes a tabbed interface; and

FIG. 5 illustrates an exemplary method for providing a conversational user interface to a customer of a retail location.

### DETAILED DESCRIPTION

The present invention extends to methods, systems, and computer program products for providing a conversational user interface (CUI) which interacts audibly with a customer of a retail location. The CUI can ask questions to or respond to questions from the customer, provide audible information regarding products or services available within the retail location, or otherwise assist the customer as the customer shops at the retail location. The CUI can be provided on virtually any device capable of outputting audio content including portable devices such as mobile phones, smart phones, tablets, gaming devices, and stationary devices such as televisions, monitors, or other display devices.

In one embodiment, the present invention provides a method for providing a conversational user interface to a customer of a retail location. A computing system identifies a customer of a retail location, and accesses stored information about the customer. The computer system then communicates audibly with the customer to provide information about products available within the retail location, and responds to communications received from the customer regarding the products.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

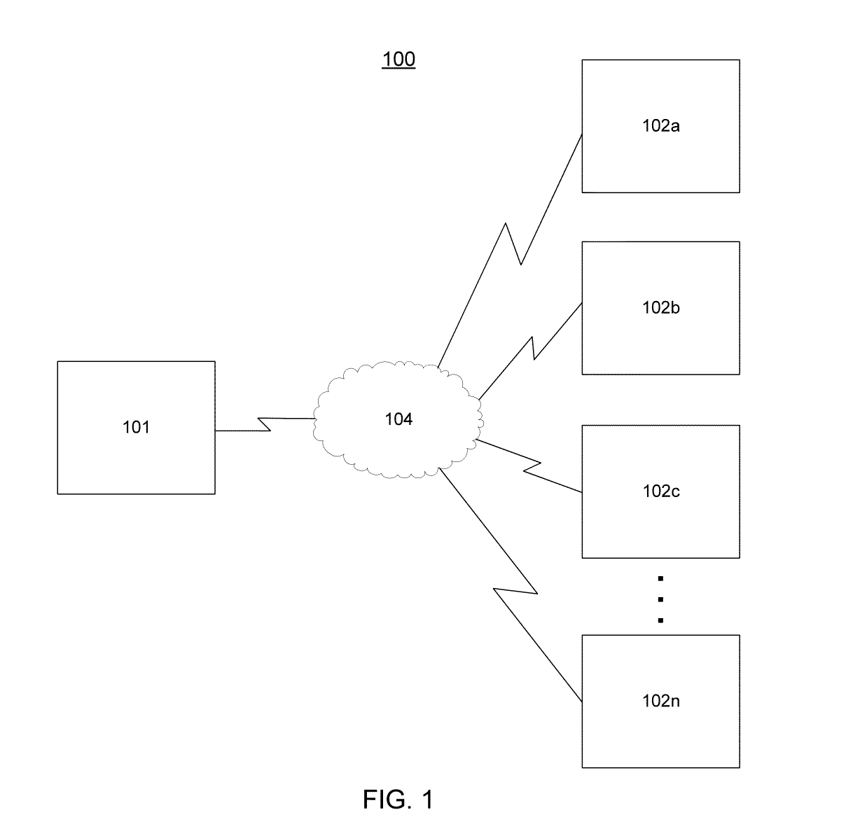

FIG. 1 illustrates an exemplary computer environment 100 in which the present invention can be implemented. Computer environment 100 includes server system 101, and customer computing devices 102a-102n. Customer computing devices 102a-102n can access content provided by server system 101 via network 103.

Server system 101 can comprise any number and type of computing devices or components. For example, server system 101 can comprise a single server device or a plurality of interconnected server components forming a cloud.

Customer computing devices 102a-102n can be any of various types of devices including desktop computers, laptop computers, tablets, smart phones, televisions, computer monitors, or other devices capable of displaying a user interface.

Network 103 can represent various types of networks such as the internet, a local area network within a retail outlet, or any other type of network that allows content to be transferred from server system 101 to customer computing devices 102a-102n.

Although FIG. 1 depicts that customer computing devices 102a-102n obtain information from server system 101, in some implementations, a customer computing device 102 can provide a CUI without receiving information from server system 101. For example, a customer computing device 102 can provide a CUI based only or partially on information received directly from the customer. However, in many embodiments, the CUI is configured to receive information either stored or obtained by server system 101.

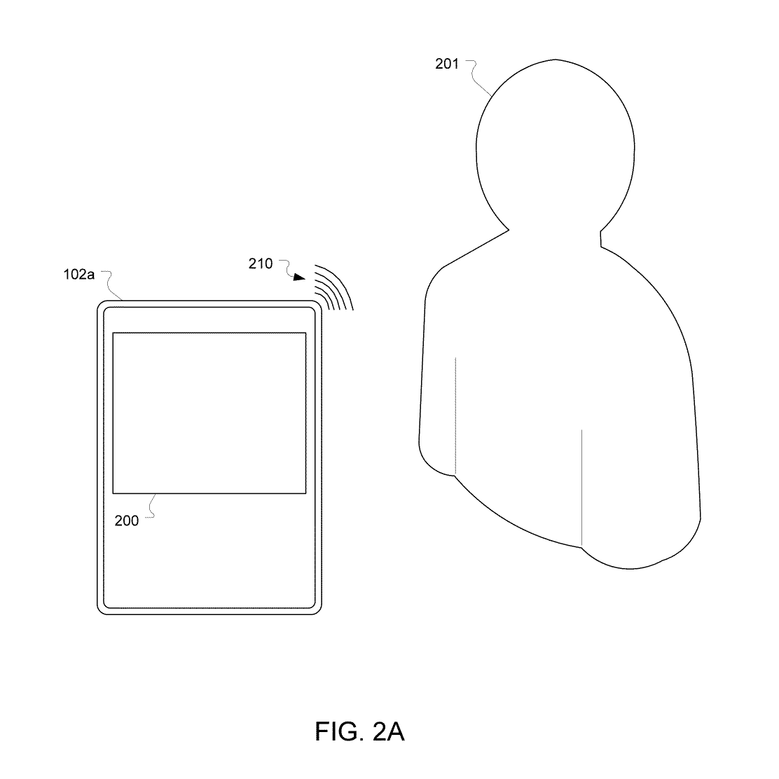

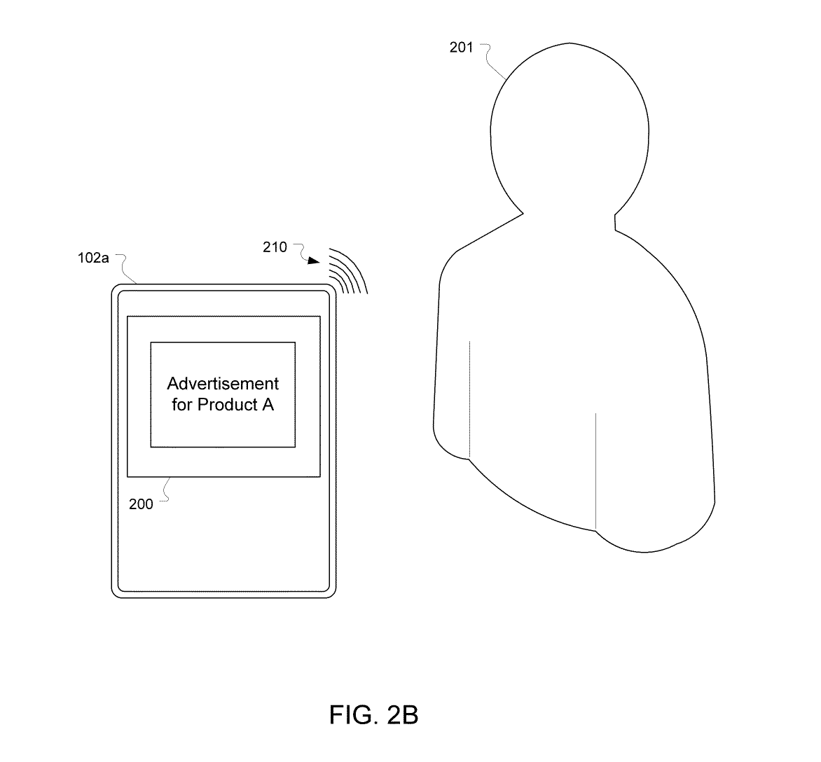

FIG. 2A illustrates an exemplary customer computing device 102a that provides a user interface 200 that can be displayed to a customer 201. User interface 200 is an example of conversational user interface (“CUI”) that can be provided in some embodiments of the invention to facilitate the provision of store information to a customer.

As shown, user interface 200 provides audio output 210 to present information to customer 201. User interface 200 can also be configured to receive input from customer 201 including audio input (e.g. via a microphone), tactile input (e.g. via a touchscreen, keypad, or other input device), video input (e.g. via a camera), etc. In a particular embodiment, a CUI can include a microphone for receiving spoken input from customer 201 and a speaker for providing audio output to customer 201.

For example, user interface 200 can be configured to detect spoken questions from customer 201, process the question, and output an audible answer or other information to customer 201. In this way, the CUI allows the customer to engage in a conversation with the user interface. For example, the CUI can be configured to greet the customer, and discuss product information, product pricing, or product location with the customer.

The CUI can also be configured to answer questions about products and combine the knowledge of the products with information from a customer's profile. For example, a customer could ask the CUI, “How many Weight Watchers points are there in this box of cereal?” The CUI may respond by clarifying, “This store carries 17 ounce and 32 ounce boxes, which size is your box?” The shopper could respond, “The 17 ounce box.” The CUI could then provide additional information such as: “That box has 20 points in it which is about half of your daily allowance.”

In another example, a customer may ask the CUI, “Do you have any offers for my family?” The CUI could respond, speaking for the store: “We have several, try this one.” In some embodiments, the conversation may be accompanied by an image of the product offered, a link to a website with product information, coupons for the product, or other information about the product.

In some embodiments, the CUI can be configured to output customized advertisements of other information to the customer. This output can be audio and/or visual output. For example, FIG. 2B illustrates user interface 200 when an advertisement for Product A.

The output of a particular advertisement can be triggered based on the nature or location of a conversation with the customer, or based on purchase history, preferences, or past conversations with the customer. For example, if the conversation includes certain keywords or topics, advertisements for products related to the keywords or topics can be presented to the customer. Similarly, it can be determined that the customer is located near a product in a store, and the CUI can display an advertisement for the product. A customer's location can be determined in any way including by using the customer's mobile communications device to detect an audio beacon within the store.

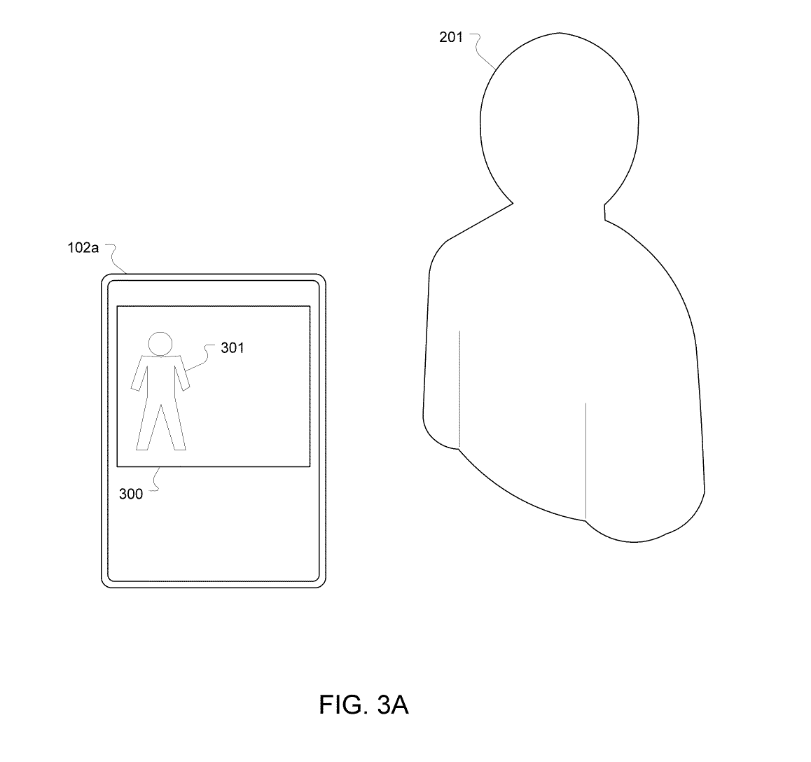

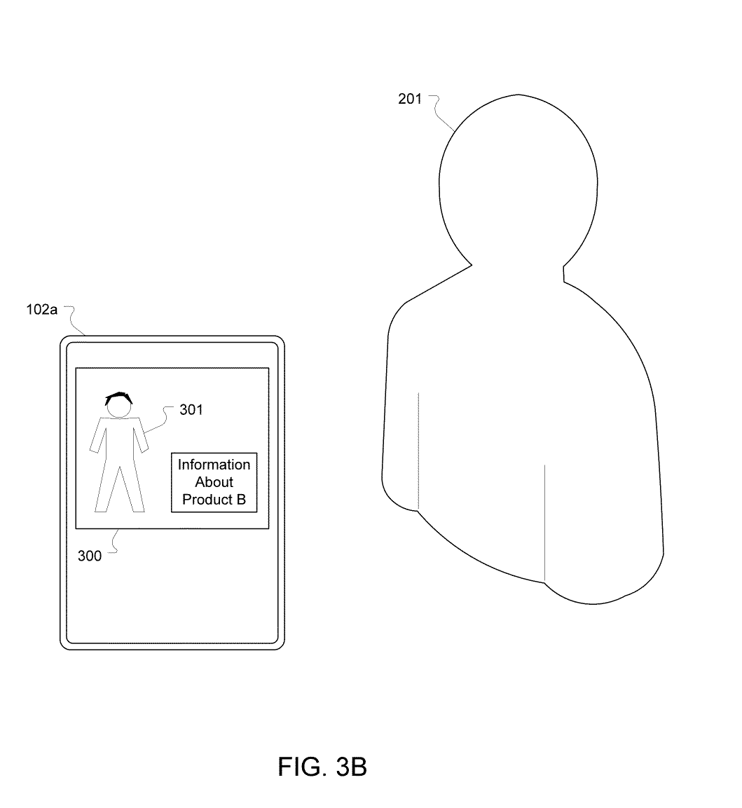

FIG. 3 illustrates another embodiment of a user interface 300 that includes an avatar 301. User interface 300 can function is the same manner as user interface 200 with the addition of an avatar. The avatar can be a graphical image of a person or other character that can move, talk, and interact with the customer via user interface 300. The avatar can thus act as a means through which the customer communicates and controls the user interface. In some instances, the avatar can look like a famous actor, actress, athlete, politician, cartoon character, or comedian. The avatar can also be an animal or other type of character.

In some embodiments, the physical characteristics of the avatar can be optimized over time based on the user's response to the avatar. For example, if it is determined that the user does not respond well to the avatar having the voice of a male, the avatar can be changed to include the voice of a female or a child. Similarly, as shown in FIG. 3B, the avatar's hair, eyes, skin, etc. can be adjusted over time. As also shown in FIG. 3B, information about a product, advertisements, promotions, etc. can be displayed in conjunction with the avatar.

When the user interface is included in a mobile device (e.g. that the customer brings into a store or obtains at the store), the avatar can function as a host or sales associate that greets the customer and guides the customer through the store while conversing with the customer. For example, when a customer enters the store, an avatar can greet the customer and ask if he needs help finding anything.

A user interface according to the present invention can also enable a customer to query whether one or more stores carries a particular product. If it is determined that the product is not available, a notification can automatically be sent to the customer when the product becomes available. For example, if the user interface is part of a mobile application on a customer's smart phone, a notification can be sent to the mobile application for display on the customer's smart phone. Similarly, an email, text, phone call, or other notification can also be sent to a customer.

In some embodiments, the user interface can provide inventory information to the user even if a desired item is not generally held in stock by the particular store or group of stores. For example, a store may not have a product in stock and may not anticipate having the item in stock because it does not have a relationship with the proper supplier. By tracking customer requests for such products, it can be determined that a particular product should be stocked or should be ordered for the requesting customers.

In some embodiments, the user interface can be used to track customer preferences. For example, if a customer asks the user interface for a product that is not available, the store can identify the product as a potential product that customer's may purchase. In some embodiments, in response to a request for a product that is not available at a store, the user interface can suggest alternative products available at the store, or suggest alternative locations that stock the requested product.

In another example, customer requests can be tracked to determine whether the price of a product should be adjusted. For example, a customer may ask the user interface: “Do you have soda for less than two dollars?” If the store does not have soda for less than two dollars, the user interface can flag soda as a product that potentially needs a price adjustment. Similarly, the user interface can track customer interaction to identify which products are requested, reviewed, or purchased through the user interface.

In some embodiments, the user interface can be configured to detect a customer's input behaviors in order to predict or determine the customer's current disposition. These predictions or determinations can be used to calculate the customer's likelihood of purchasing certain products at that time, and can display advertisements accordingly. For example, if it is determined that a customer is highly likely to make a purchase, the user interface can advertise higher-priced items or items that the customer may not typically purchase. In contrast, if it is determined that the customer is not likely to make a purchase, the user interface can refrain from presenting advertisements or advertise products that are easier to sell or highly discounted.

A customer's input behaviors can be monitored in various ways. For example, the user interface can analyze the customer's speech patterns and determine that the customer is more likely to purchase a product when the customer speaks more slowly or more rapidly, or uses a high or low pitched voice. When the user interface is used on a device having a touch screen, the user interface can track the number of times the customer taps to select an item, the force with which the customer taps the screen, or the speed at which the customer toggles through a list of products. By analyzing this behavior, the user interface can determine which advertisements or information is most likely to persuade the customer to purchase a product.

In some embodiments, the user interface can attempt to discover what the customer's purpose for shopping is. For example, the user interface can directly ask the customer why he is shopping, who or what he is shopping for, whether anyone else is shopping with him, etc. In other cases, the user interface can ask more general questions that will likely invoke answers that will reveal the purpose. Based on an identified purpose, the user interface can provide information or advertisements that will help the customer achieve the purpose or that will entice the customer to purchase certain products.

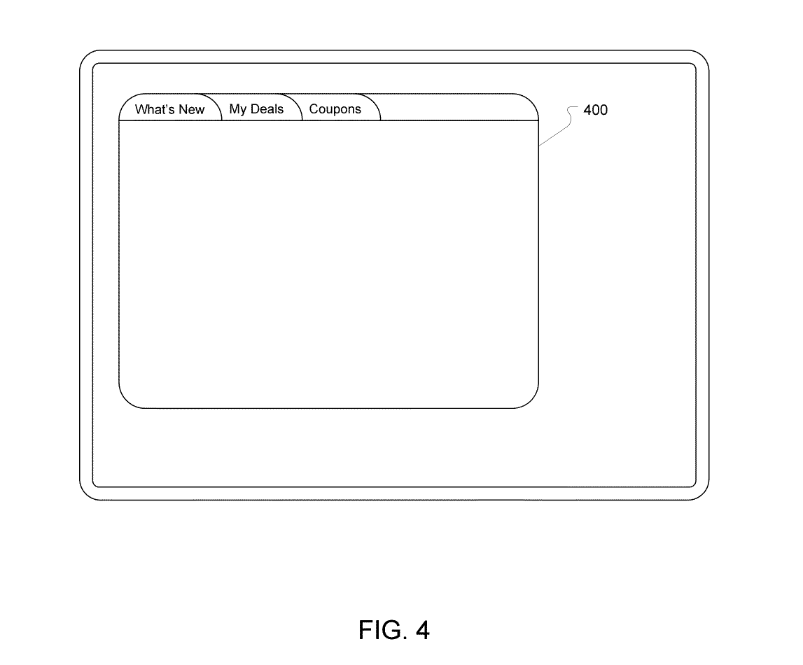

FIG. 4 illustrates a user interface 400 that employs tabs to segregate information or advertisements. As shown, user interface 400 includes three tabs. A “What's New” tab includes information or advertisements about new products available at the store, a “My Deals” tab includes offers that have been made to the customer for particular products or services available at the store, and a “Coupons” tab includes current coupons available for use. Based on which tab a customer is viewing, the user interface can customize a conversation, advertisements, or other information being output to customer whether as audio and/or video output.

In some embodiments, a user interface can customize content to output to a customer based on the customer's social graph. A social graph refers to a mapping of relationships a customer has with other individuals. For example, the user interface can utilize the customer's Facebook profile to determine who the customer's friends are. Based on this information, the user interface can select content related to products or services that the customer's friends have been interested in or have purchased.

In some embodiments, a user interface can be configured to receive a photograph of a customer's pantry or other food storage location. The user interface can analyze the photograph to identify the type, brand, size, etc. of products in the photograph. For example, the user interface can be configured to identify text, logos, or other designs on products in the photograph.

When a product is identified in the photograph, an advertisement, coupon, or other information can be displayed on or by the user interface. For example, if a generic brand of cereal is identified in the photograph, the user interface can determine that the name brand cereal is on sale or identify a coupon for the name brand cereal that will likely entice the customer to purchase the name brand. Similarly, the user interface can recommend products that go with a product identified in the photograph.

In some embodiments, the user interface can use the photograph or a series of photographs to create an inventory of the customer's purchased products. The user interface can use the inventory to create a shopping list for the customer, identify coupons for items on the shopping list, etc.

As stated above, the user interface can be displayed on or provided by virtually any device including portable or stationary devices. In some embodiments, a holder for a portable device can be provided on a shopping cart, basket, or other structure used to contain products while shopping. For example, the holder can comprise a tray or clip that is permanently or temporarily attached to a shopping cart into which a portable device can be inserted. The portable device can be the customer's portable device (e.g. a phone, tablet, gaming device, etc.) or a portable device provided by the store. When the portable device is provided by the store, the portable device can allow the customer to log in such as by inputting login credentials, swiping a card (e.g. a loyalty card), etc.

The portable device can communicate with other devices within the store (e.g. other displays containing information such as advertisements, or a user interface according to the present invention). These communications can include detecting the location of the portable device within the store.

In embodiments where the holder holds a loyalty or other identification card, the holder can orient the loyalty card so that it can be scanned by one or more scanners located in various locations throughout the store. For example, the loyalty card can include a barcode or RFID chip that is detected by the scanners. In such embodiments, the user interface described above can be provided on a portable device attached to a shopping cart or on one or more displays located throughout the store.

In embodiments where the holder holds a portable device having a display, the user interface can be continually displayed to the customer on the portable device as the customer pushes the shopping cart around the store.

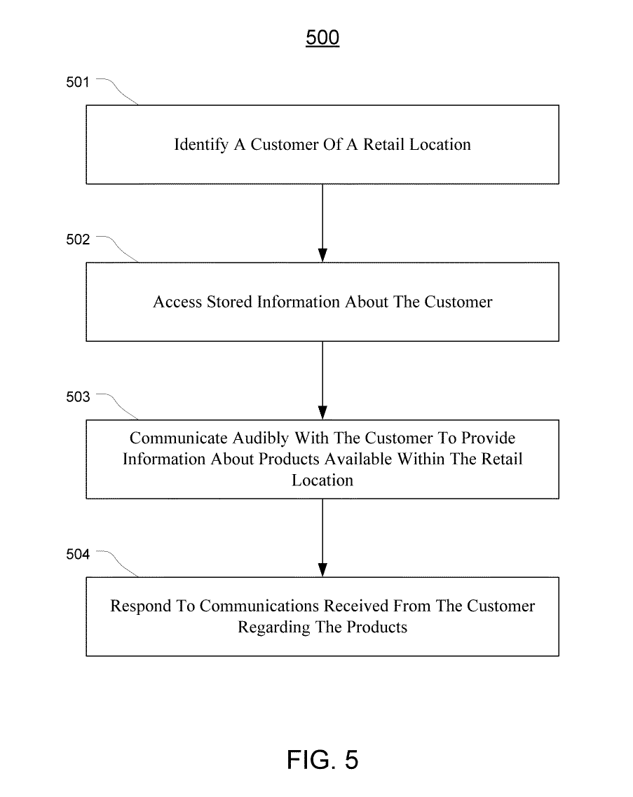

FIG. 5 illustrates a flowchart of an exemplary method 500 for providing a conversational user interface to a customer of a retail location. Method 500 can be implemented by a computing system that includes a speaker for outputting audible communications. Method 500 will be described with reference to the figures.

Method 500 includes an act 501 of identifying, by the computing system, a customer of a retail location. For example, user interface 200 executing on customer computing device 102a can identify customer 201 such as by receiving input from customer 201, or accessing account information about customer 201 (e.g. when customer computing device 102a comprises the customer's portable device on which the CUI is executing) etc.

Method 500 includes an act 502 of accessing stored information about the customer. For example, user interface 200 can access purchase history, preferences, or other information that has been compiled about customer 201.

Method 500 includes an act 503 of communicating audibly with the customer to provide information about products available within the retail location. For example, user interface 200 can cause audible communications 210 to be output to customer 201 to provide advertisements, product information, product location, etc.

Method 500 includes an act 504 of responding to communications received from the customer regarding the products. For example, in response to input from customer 201, user interface 200 can output audio and/or visual information to customer 201 regarding the products.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a computing system that includes a speaker for outputting audible communications, for providing a conversational user interface (CUI) to a customer of a retail location, the method comprising:
identifying, by the computing system, a customer of a retail location;
accessing stored information about the customer;
communicating audibly with the customer to provide information about products available within the retail location; and
responding to communications received from the customer regarding the products.

2. The method of claim 1, wherein the computing system comprises a portable computing device carried by the customer.

3. The method of claim 2, wherein the portable computing device comprises the customer's smart phone.

4. The method of claim 2, wherein identifying the customer of the retail location comprises accessing an account of the customer stored on the portable computing device.

5. The method of claim 2, wherein identifying the customer of the retail location comprises receiving input from the customer.

6. The method of claim 5, wherein the input comprises scanning an identification card of the customer or detecting a wireless transmission of an identifier of the customer.

7. The method of claim 1, wherein accessing stored information about the customer comprises accessing one or more of: preferences of the customer, purchase history of the customer, individuals with which the customer has a relationship, or prior interaction the customer has had with the CUI provided by the computing system.

8. The method of claim 1, wherein communicating audibly with the customer to provide information about products available within the retail location comprises:
determining that the customer is located near a product in the retail location; and
providing an advertisement or information about the product.

9. The method of claim 1, wherein communicating audibly with the customer to provide information about products available within the retail location comprises:
identifying a product that the customer desires to purchase;
determining the location of the product in the retail location; and
providing directions to guide the customer to the location of the product.

10. The method of claim 1, wherein communicating audibly with the customer to provide information about products available within the retail location comprises asking the customer a question.

11. The method of claim 10, wherein the question relates to one or more of: a product, a purpose for a customer's visit to the retail location, or a reminder of an event in the customer's life.

12. The method of claim 1, wherein responding to communications received from the customer regarding the products comprises:
answering a question from the customer, the question related to one or more of: the availability of a product in the retail location, the location of a product within the retail location, or information about a product.

13. The method of claim 1, wherein the computing system includes a display device, the method further comprising:
displaying an avatar on the display device, the avatar communicating audibly with the customer, and responding to communications received from the customer.

14. The method of claim 1, wherein the computing system includes a display device, the method further comprising:
displaying information about one or more products on the display device while communicating audibly with the customer.

15. The method of claim 1, wherein the computing system includes a display device, the method further comprising:
displaying a tabbed display that segregates, among tabs of the tabbed display, information about products available at the retail location.

16. The method of claim 1, further comprising:
receiving one or more photographs from the customer, the one or more photographs including products that the customer has purchased;
analyzing the one or more photographs to identify the products;
providing information related to the identified products, including one or more of:
generating a shopping list based on a comparison of products shown in one photograph that are not shown in another photograph;
recommending one or more products that are related to one or more products in the one or more photographs; or
providing advertisements, coupons, or other information regarding one or more products in the photograph or one or more products that are related to one or more products in the photograph.

17. The method of claim 1, wherein the communications received from the customer comprises audible communications, and wherein responding to the communications comprises:
analyzing the audible communications received from the customer; and
providing information about one or more products based on the analysis of the audible communications.

18. The method of claim 1, wherein analyzing the audible communications comprise:
determining the rate at which the customer speaks; or
determining the pitch of the customer's voice.

19. The method of claim 1, wherein the computing system includes a display device on which the CUI is displayed, and wherein responding to the communications further comprises:
analyzing the customer's tactile interactions with the display device.

20. The method of claim 1, wherein the computing system comprises a portable device that is configured to be attached to a holder on a shopping cart.
